(19) United States
(12) Patent Application Publication
(10) Pub. No.: US 2011/0126720 A1
(43) Pub. Date: Jun. 2, 2011

(54) My invention is a sort waffle maker that makes waffle and pancake out of cartoon character

(76) Inventor: Cornelius Devon Galvin, Killeen, TX (US)

(21) Appl. No.: 12/584,986

(22) Filed: Nov. 27, 2009

(51) Int. Cl. A47J 37/06

(52) U.S. Cl. 99/378

(57) ABSTRACT

This is an electronic waffle-maker that shape waffle and pancake dough into the forms of cartoon character. The idea is to be able to cook waffle and pancakes in the shapes of cartoon character. Inside of the waffle-maker comes with unlimited plates so there is a choice of any cartoon character as the shape of waffles. The waffle-maker comes with one character plate. Other plates in the shapes of any other cartoon character are offered in stores and can be ordered. This waffle-maker uses a steal heating coil to cook the waffle or pancakes. Is has a timer on the top that flashes after about four minutes to indicate that the waffle are done. The waffle-maker is meant to appeal to children who should enjoy eating waffles in the shapes of character they know.

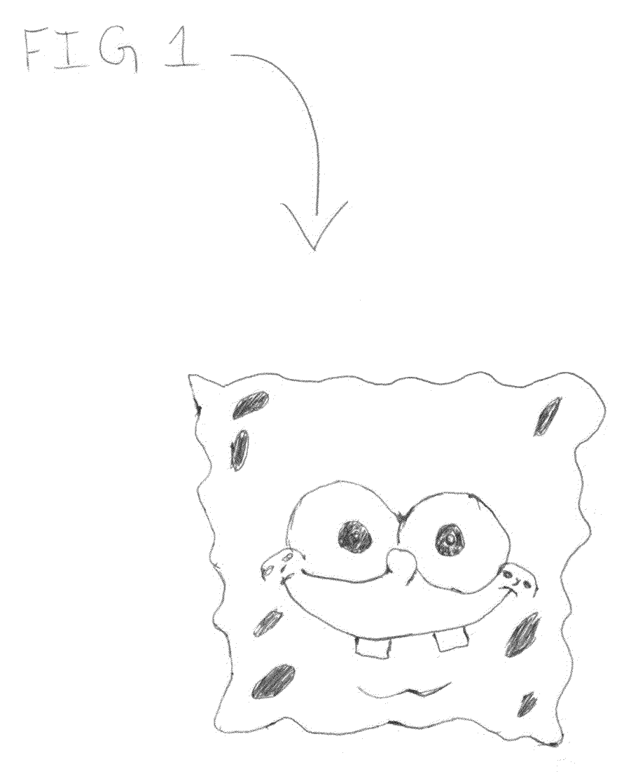

FIG. 1 Show the cartoon character and it is made out Teflon and the Teflon plates will be carve into the shape of any cartoon character and it is for the insides top and bottom waffle-maker.

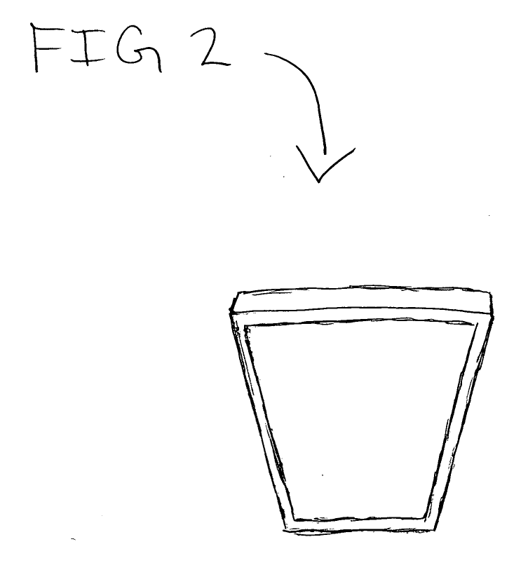

FIG. 2 Show the top part of the waffle-maker the outside is made out of plastic the inside is made out of Teflon and is carve into the shape of any cartoon character. It has four sides and they all are rectangular. With a heating element in the inside and it is a steal coil. With a timer, latch on the front and a left and right hinges in the back.

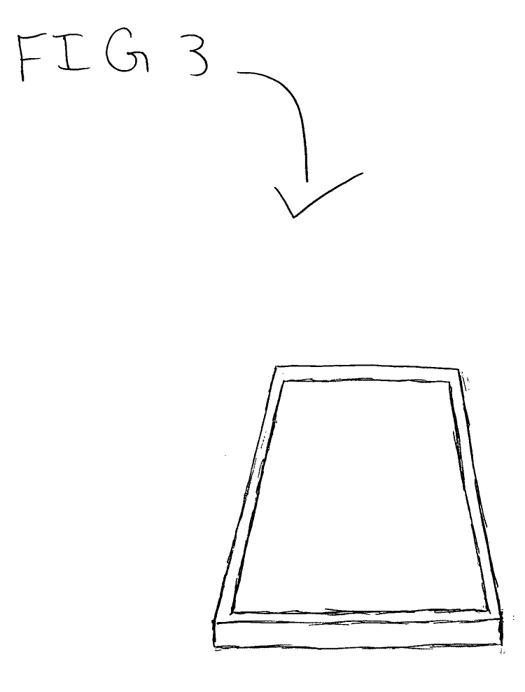

FIG. 3 Show the bottom part of the waffle-maker the outside is made out of plastic the inside is made out of Teflon and the Teflon plates is carve into the shape of any cartoon character. It has four sides and they all are rectangular with a heating element in the inside and it is a steal coil with a bottom latch and a left and right hinge in the back.

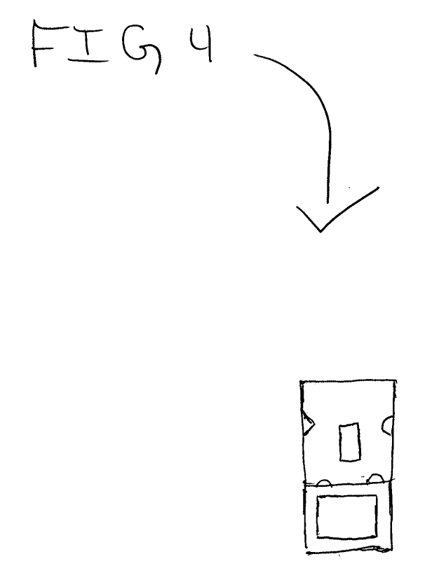

FIG. 4 Show the top latch and it is part of the top waffle-maker.

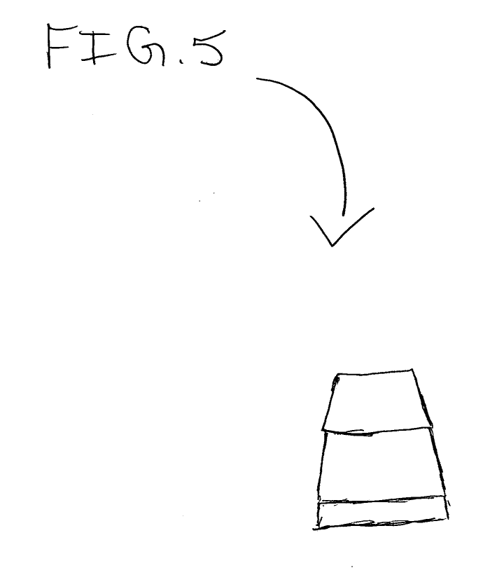

FIG. 5 Show the bottom latch and it is part of the bottom waffle-maker.

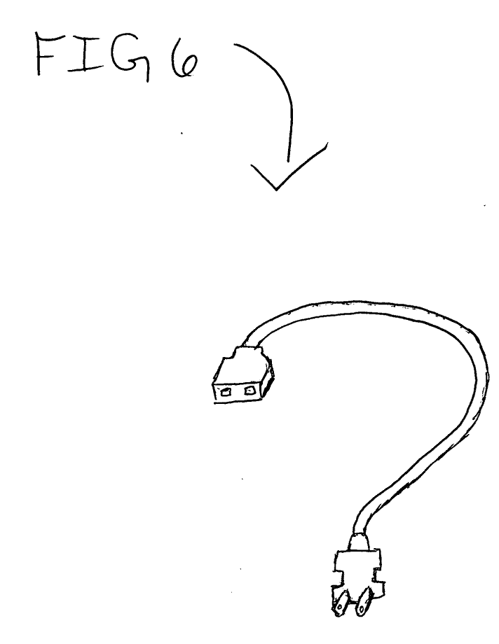

FIG. 6 Show the electric power cord and it is a part of the bottom waffle-maker.

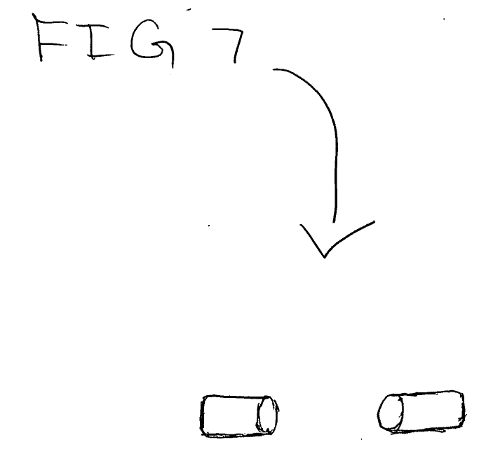

FIG. 7 Show the left and right hinges and they are a part of the top and bottom waffle-maker.

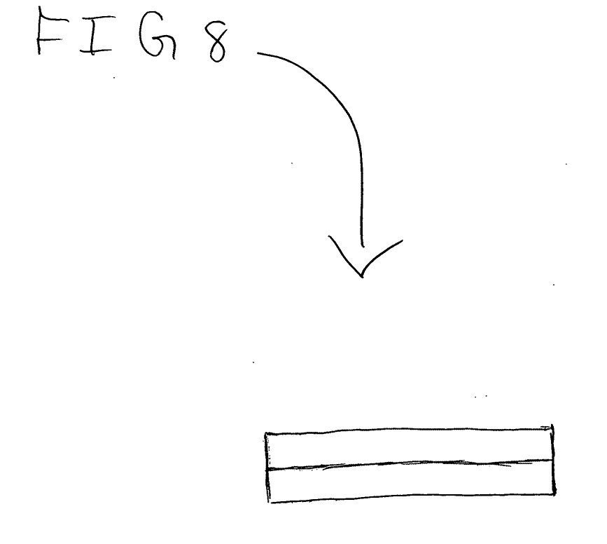

FIG. 8 Show the side view and it is part of the top and bottom waffle-maker.

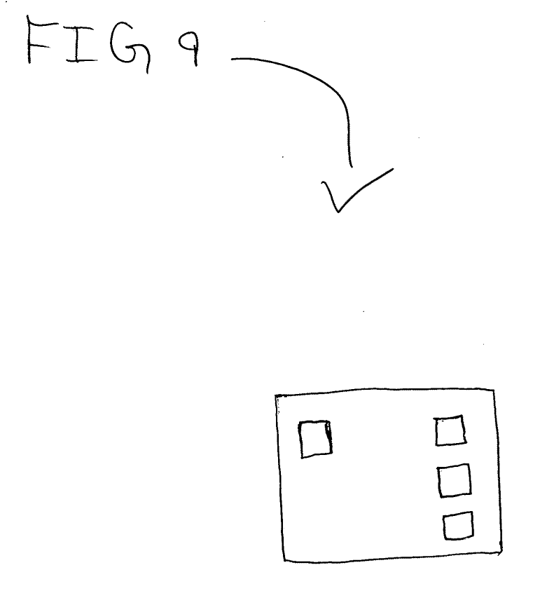

FIG. 9 Show the adapter and it is part of the bottom inside of the waffle-maker.

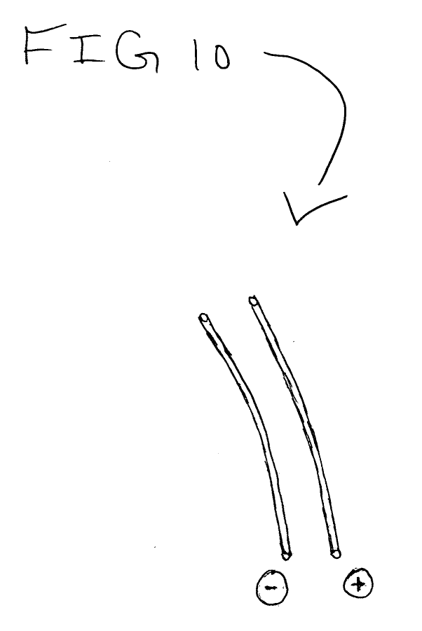

FIG. 10 Show the wires and they are a part of the adapter and the bottom inside of the waffle-maker.

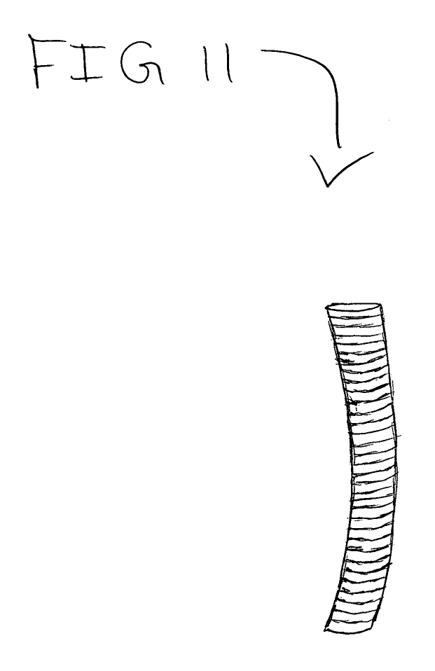

FIG. 11 Show the heating element and it is a steal coil it is part of the top and bottom inside of the waffle-maker.

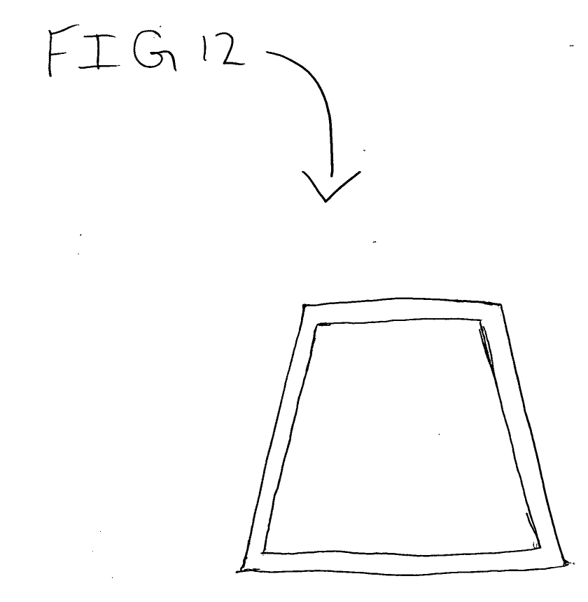

FIG. 12 Show the inside of the waffle-maker and it is Teflon and this Teflon plate will be carve into the shape of any cartoon character and it is the insides of the top and bottom waffle-maker.

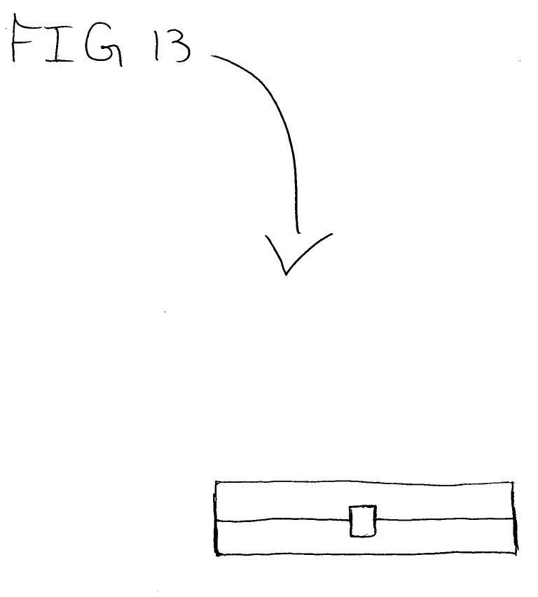

FIG. 13 Show the front view and it is a part of the top and bottom waffle-maker and it has a top and bottom latch.

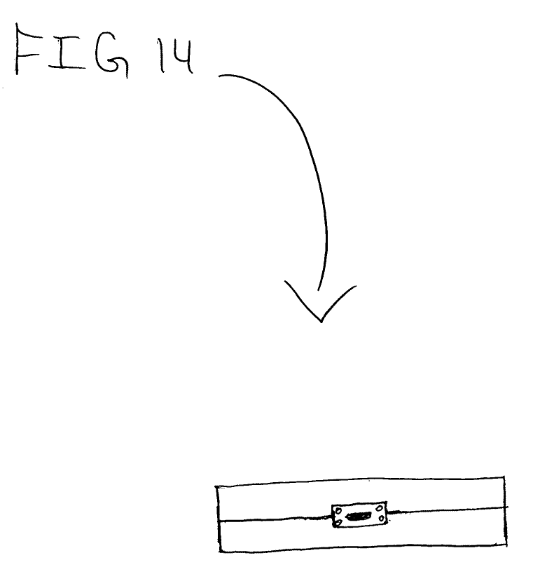

FIG. 14 Show the back view and it is a part of the top and bottom waffle-maker and it has a left and right hinges.

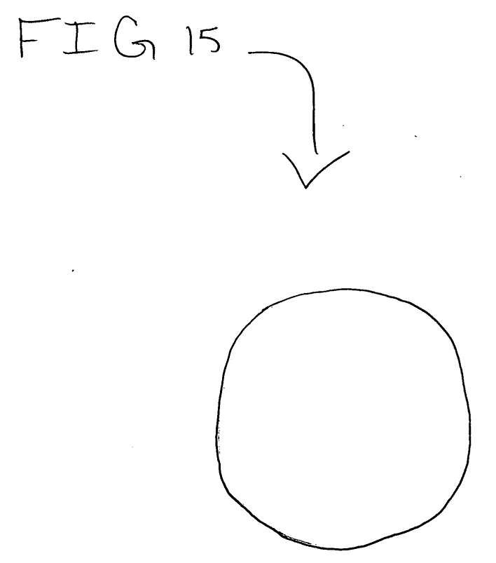

FIG. 15 Show a timer and it is a part of the top waffle-maker.

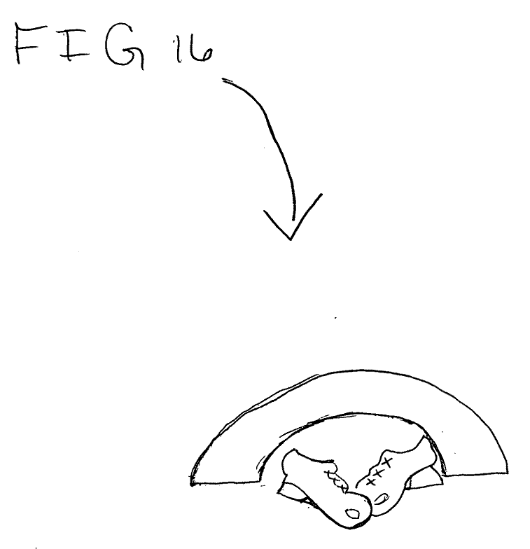

FIG. 16 Show a stand and it is part of the bottom of the waffle-maker and it has feet connected to the stand in the shape of any cartoon character.

### BACKGROUND OF THE INVENTION

This waffle-maker is a great ideal for children. It can be used at home or in a restaurant. I believe kids will enjoy theses unlimited plates. You can buy one waffle-maker but will be able to switch out the plates. This way you have a pick of your different favored cartoon character. So you don't have to buy ten different cartoon waffle-makers. This waffle-maker can also be used for teenager and adult. There are teenager and adult to this day who enjoy cartoon character. With unlimited cartoon plates this waffle-maker will be a great ideal to invent.

### DETAILED DESCRIPTION OF THE INVENTION

Inside of the waffle-maker is made out of Teflon and this Teflon plates will be carve into the shape of any cartoon character. The outside is made out of plastic. The cartoon characters will be in the inside of the waffle-maker. The top part of the waffle-maker is connected to the bottom. There is a right and a left hinge that connects the top and bottom waffle-maker together. The top latch is connected to the top front of the waffle-maker. The bottom latch is connected to the bottom front of the waffle-maker. There is an electric power chord connected to the back bottom of the waffle-maker. There are eight sides to the top and bottom part and they all are in the shape of a rectangular. The adapter is connected to the inside bottom part of standard insulation. The positive and negative wires are connected to the adapter. There is a heating element and it is a steal coil connected to the inside top and bottom inside. On the top of the waffle-maker there is a timer that flashes yellow to indicate that the waffle is cook. And the bottom of the waffle-maker has a stand that slide into the bottom and this stand has feet in the shape of any cartoon characters.

### BRIEF SUMMARY OF THE INVENTION

These 16 FIG. Is what makes this waffle-maker complete. You have the top part of the waffle-maker. You have the bottom part of the waffle-maker. There is a left and a right hinge. You have the top and bottom latch. This waffle-maker is electric so there is an electric power chord. There are eight sides to the top and bottom of the waffle-maker and each side is in the shape of a rectangular. There is an adapter. There are two wires a positive and a negative. You have a heating element and it is a steal coil. The insides of the top and bottom of the waffle-maker are made out of Teflon and these Teflon plates are carve in the shape of cartoon characters. The top part of the waffle-maker also has a timer on top of it. With a stand that slide into the bottom and this stand has feet on it that's in the shape of any cartoon characters.

1. This is an electric waffle-maker that cooks waffle and pancakes into the shape of any cartoon character. Using an electric heating coil and Teflon cartoon plates to cook the dough and make the shapes
